(19) United States
(12) Patent Application Publication
(10) Pub. No.: US 2026/0104005 A1
(43) Pub. Date: Apr. 16, 2026

(54) Continuously Variable Displacement and Variable Compression Ratio Mechanism and an Engine Provided with the Same

(71) Applicants: HYUNDAI MOTOR COMPANY, Seoul (KR); KIA CORPORATION, Seoul (KR)

(72) Inventors: Jinyoung Jung, Hwaseong-si (KR); Seung Woo Lee, Hwaseong-si (KR); Kiyoung Kwon, Hwaseong-si (KR); Sangyeon Han, Hwaseong-si (KR); Jin Su Han, Hwaseong-si (KR); Young Nam Kim, Hwaseong-si (KR); You Sang Son, Hwaseong-si (KR); Back Sik Kim, Hwaseong-si (KR); Sangjae Park, Hwaseong-si (KR)

(73) Assignees: HYUNDAI MOTOR COMPANY, Seoul (KR); KIA CORPORATION, Seoul (KR)

(21) Appl. No.: 19/353,380

(22) Filed: Oct. 8, 2025

(30) Foreign Application Priority Data
Oct. 14, 2024 (KR) 10-2024-0139862
May 20, 2025 (KR) 10-2025-0065175

(51) Int. Cl. F02B 75/04; F02D 15/02

(52) U.S. Cl. CPC F02B 75/045; F02D 15/02

(57) ABSTRACT

A continuous variable displacement and variable compression ratio mechanism includes: a connecting rod connected to a piston with a piston pin; a first auxiliary linkage connected to the connecting rod; a crankshaft connected to the first auxiliary linkage and rotatable by the first auxiliary linkage; a second auxiliary linkage connected to the first auxiliary linkage; a control shaft connected to the second auxiliary linkage; and a phase controller that is configured to change the relative position of the second auxiliary linkage that rotates the control shaft.

### CROSS-REFERENCE TO RELATED APPLICATION

This application claims priority to and the benefit of Korean Patent Application No. 10-2024-0139862 filed with the Korean Intellectual Property Office on Oct. 14, 2024, and Korean Patent Application No. 10-2025-0065175 filed with the Korean Intellectual Property Office on May 20, 2025, the entire contents of which are incorporated herein by reference.

### BACKGROUND

### (a) Field of the Disclosure

The present disclosure relates to a continuous variable displacement and variable compression ratio mechanism and an engine provided with the same.

### (b) Description of the Related Art

In an internal combustion engine, increasing the compression ratio can improve engine efficiency, i.e. fuel efficiency, and improve combustion stability under low-load conditions such as engine idle.

On the other hand, if the compression ratio increases under high load conditions, the knock characteristics may deteriorate, causing deterioration of maximum output and increase in Low End Torque (LET) revolutions per minute (rpm).

Therefore, it is necessary to select an appropriate compression ratio considering the fuel efficiency and output of the engine and vehicle type.

As the displacement of an internal combustion engine increases, the power per unit volume of the cylinders decreases, and fuel efficiency may be deteriorated due to increased pumping at low loads. On the other hand, as the displacement increases, the knock characteristic improves at high loads, which can improve output and fuel efficiency.

In other words, there is an optimal compression ratio and displacement for each driving condition. For typical engines, the compression ratio and displacement are fixed and applied according to the required performance.

The information contained in this background section is intended to promote understanding of the background of the disclosure and may include subject matter that is not conventional art already known to a person of ordinary skill in the field to which this technology belongs.

### SUMMARY

The present disclosure provides a continuous variable displacement and variable compression ratio mechanism capable of varying the displacement and compression ratio, and provides an engine equipped with the same.

A continuous variable displacement and variable compression ratio mechanism according to the present disclosure may include: a connecting rod connected to a piston with a piston pin; a first auxiliary linkage connected to the connecting rod; a crankshaft connected to the first auxiliary linkage and rotated by the first auxiliary linkage; a second auxiliary linkage connected to the first auxiliary linkage; a control shaft connected to the second auxiliary linkage; and a phase controller that changes the relative position of the second auxiliary linkage that rotates about the control shaft.

The second auxiliary linkage and the first auxiliary linkage may be connected via a first pivot point, the first auxiliary linkage and the connecting rod may be connected via a second pivot point, and the crankshaft and the first auxiliary linkage may be connected via a third pivot point located between the first pivot point and the second pivot point.

The second auxiliary linkage and the control shaft may be connected via a control pivot that rotates the exterior circumference of the control shaft.

The control shaft and the crankshaft may rotate in the same direction. The compression ratio may be reduced by advancing the relative phase of the control pivot with respect to the control shaft according to the operation of the phase controller.

The control shaft and the crankshaft may rotate in the same direction. The displacement may be increased by advancing the relative phase of the control pivot with respect to the control shaft according to the operation of the phase controller.

The crank pin of the crankshaft may form the third pivot point and the first auxiliary linkage may swing in the space between crank webs of the crankshaft.

The rotation center of the crankshaft may be offset by a predetermined distance from the driving direction of the piston pin.

A continuous variable displacement and variable compression ratio mechanism according to the present disclosure may include: a connecting rod connected with a piston via a piston pin; a first auxiliary linkage connected to the connecting rod; a crankshaft connected to the first auxiliary linkage via a crank pin and rotated by the first auxiliary linkage; and a compression ratio controller that changes the movement trajectory of the connecting portion of the connecting rod and the first auxiliary linkage according to an operation status of the engine.

The compression ratio controller may include a second auxiliary linkage connected to the first auxiliary linkage, a control shaft connected to the second auxiliary linkage, and a phase controller that changes the relative position of the second auxiliary linkage that rotates about the control shaft.

The second auxiliary linkage and the first auxiliary linkage may be connected by a first connecting pin, the first auxiliary linkage and the connecting rod may be connected by a second connecting pin, and the crank pin may be placed between the first connecting pin and the second connecting pin.

The second auxiliary linkage and the control shaft may be connected through a control pin that rotates the exterior circumference of the control shaft.

The control shaft and the crankshaft may rotate in the same direction and the compression ratio may be reduced by advancing the relative phase of the control pivot to the control shaft according to the operation of the phase controller.

The control shaft and the crankshaft may rotate in the same direction. The displacement may be increased by advancing the relative phase of the control pivot to the control shaft according to the operation of the phase controller.

An engine according to the present disclosure may be provided with the continuous variable displacement and variable compression ratio mechanism According to the present disclosure of a continuous variable displacement and variable compression ratio mechanism and an engine provided with the same, displacement and compression ratio can be variable with a simple configuration.

According to the present disclosure of a continuous variable displacement and variable compression ratio mechanism and an engine provided with the same, the compression ratio can be increased and the displacement can be reduced or lowered under a low load condition, thereby increasing thermal efficiency and reducing pumping loss.

According to the present disclosure of a continuous variable displacement and variable compression ratio mechanism and an engine provided with the same, the compression ratio can be reduced and the displacement can be increased under a high load condition, thereby lowering the power per unit volume of the cylinders and improving the knock characteristic.

In addition, any effects that can be obtained or expected due to the present disclosure are directly or implicitly disclosed in the detailed description of the present disclosure. In other words, various effects predicted according to the present disclosure are disclosed in the detailed description that follows.

### BRIEF DESCRIPTION OF THE DRAWINGS

Since these drawings are for reference in explaining embodiments of the present disclosure, the technical ideas of the present disclosure should not be interpreted as being limited to the attached drawings.

FIG. 1 is a side view of a continuous variable displacement and variable compression ratio mechanism according to the present disclosure.

FIG. 2 is a edge view of a continuous variable displacement and variable compression ratio mechanism according to the present disclosure.

FIG. 3 is a schematic diagram of an engine provided with a continuous variable displacement and variable compression ratio mechanism according to the present disclosure.

FIGS. 4A-7B are drawings showing the operation of a continuous variable displacement and variable compression ratio mechanism according to the present disclosure.

FIG. 8 is a graph showing the compression ratio variation according to phase change of a continuous variable displacement and variable compression ratio mechanism according to the present disclosure.

FIG. 9 is a graph of displacement variation according to phase change of a continuous variable displacement and variable compression ratio mechanism according to the present disclosure.

### DETAILED DESCRIPTION OF THE EMBODIMENTS

Hereinafter, with reference to the attached drawings, embodiments of the present disclosure are described in detail so that a person having ordinary skill in the art to which the present disclosure pertains can practice the present disclosure. As those of ordinary skill in the art should realize, the described embodiments may be modified in various different ways, all without departing from the spirit or scope of the present disclosure.

In order to clearly explain the present disclosure, parts irrelevant to the description have been omitted. Also, the same reference numerals are used for identical or similar components throughout the specification.

The size and thickness of each component shown in the drawings may be arbitrarily shown for convenience of explanation. The present disclosure is not necessarily limited to what is shown in the drawings. In order to clearly express various parts and areas, the line thickness may be shown in an enlarged or unrealistic form.

In addition, in the detailed description below, the names of the components maybe divided into first, second, etc. to distinguish them when the components are in a similar relationship. The description below is not necessarily limited to that order.

Throughout the specification, whenever a part is said to include a certain component, this does not mean that the part excludes other components, but rather that the part may include other components, unless otherwise specifically stated.

Additionally, terms such as . . . means, . . . part, etc. described in the specification mean comprehensive units of composition that perform at least one function or operation.

As used herein, the terms “vehicle”, “car”, “vehicular”, “automobile” or other similar terms refer to vehicles in general. Such vehicles may encompass: automobiles, including passenger cars, sports utility vehicles (SUVs), buses, trucks, and various commercial vehicles; ships, including various types of boats and vessels; aircraft; and the like. Such vehicles may also include hybrid vehicles, electric vehicles, plug-in hybrid electric vehicles, hydrogen fuel vehicles, and other alternative fuel (e.g., fuels derived from sources other than petroleum) vehicles.

When a component, device, unit, module, controller, element, or the like of the present disclosure is described as having a purpose or performing an operation, function, or the like, the component, device, unit, module, controller, or element should be considered herein as being “configured to” meet that purpose or to perform that operation or function. The present disclosure describes use of a controller. The controller or other such components may separately embody or be included with a processor and a memory, such as a non-transitory computer readable media, as part of the controller or component.

Additionally, some methods can be executed by at least one controller. The term controller refers to a hardware device that includes a memory and a processor that executes one or more steps interpreted as an algorithm structure. The memory is configured to store the steps of the algorithm, and the processor is configured to specifically execute the steps of the algorithm to perform one or more processes described below.

Embodiments of the present disclosure are hereinafter described in detail with reference to the accompanying drawings.

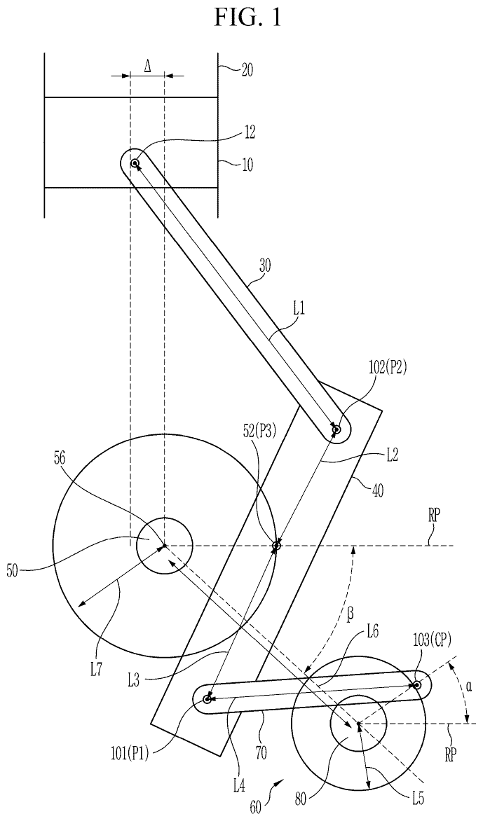

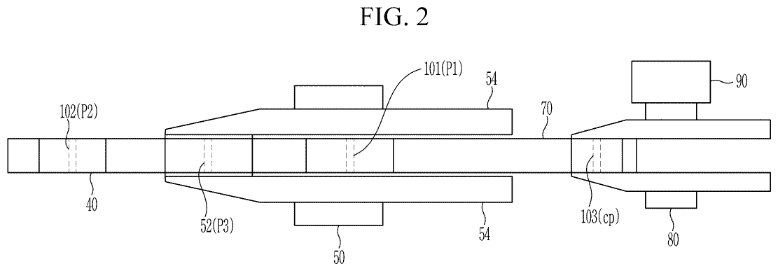

FIG. 1 is a side view of a continuous variable displacement and variable compression ratio mechanism according to the present disclosure. FIG. 2 is an edge view of a continuous variable displacement and variable compression ratio mechanism according to the present disclosure.

Referring to FIG. 1 and FIG. 2, according to the present disclosure, a continuous variable displacement and variable compression ratio mechanism may include: a connecting rod 30 connected to a piston 10 with a piston pin 12; a first auxiliary linkage 40 connected to the connecting rod 30; a crankshaft 50 connected to the first auxiliary linkage 40 and rotated by the first auxiliary linkage 40; and a compression ratio controller 60 changing a movement trajectory of a connection portion of the connecting rod 30 and the first auxiliary linkage 40 according to an operating state of an engine.

The first auxiliary linkage 40 and the crankshaft 50 are connected by a crank pin 52, so that the crankshaft 50 can rotate by the first auxiliary linkage 40.

The crank pin 52 rotates along a path formed at a constant radius from the crankshaft 50.

The movement trajectory of the connecting portion of the connecting rod 30 and the first auxiliary linkage 40 can be changed according to the operation of the compression ratio controller 60, so that the operation position and operation distance of the piston 10 can be adjusted. Through this, the compression ratio and displacement can be controlled. This is further described below.

The compression ratio controller 60 may include a second auxiliary linkage 70 connected to the first auxiliary linkage 40, a control shaft 80 connected to the second auxiliary linkage 70, and a phase controller 90 that changes a relative position of the second auxiliary linkage 70 that rotates about the control shaft 80.

The phase controller 90 is configured to change the relative phase of the rotating shaft and the control target, and may have the same or similar configuration as, for example, a continuously variable valve timing apparatus that changes the relative phase of the crankshaft 50 and the camshaft. For example, the phase controller 90 may be a hydraulic pressure type or mechanical device and may have various types of configurations that change the relative phase of the rotating components. The configuration that changes the relative phase of the rotating components should be apparent to those of ordinary skill in the art, so a detailed description has been omitted.

The second auxiliary linkage 70 and the first auxiliary linkage 40 can be connected via a first pivot point P1. For example, the second auxiliary linkage 70 and the first auxiliary linkage 40 are connected with a first connecting pin 101, and the first connecting pin 101 can function as the first pivot point P1.

The first auxiliary linkage 40 and the connecting rod 30 can be connected via a second pivot point P2. For example, the first auxiliary linkage 40 and the connecting rod 30 are connected with a second connecting pin 102, and the second connecting pin 102 can function as the second pivot point P2.

The crank pin 52 is placed between the first pivot point P1 and the second pivot point P2 so that it can function as a third pivot point P3.

The second auxiliary linkage 70 and the control shaft 80 may be connected via a control pivot CP that rotates an exterior circumference of the control shaft 80. For example, a control pin 103 connects the second auxiliary linkage 70 and the control shaft 80, and may function as the control pivot CP.

The control pivot CP of the second auxiliary linkage 70 rotates around and thus rotates the control shaft 80. The relative position of the control pivot CP, i.e., the relative phase α of the control pivot CP can be changed by the operation of the phase controller 90.

The rotation center of the crankshaft 50 may be offset Δ by a predetermined distance from a driving direction of the piston pin 12. In other words, the rotation center of the crankshaft 50 may be offset Δ from the center position of the cylinder 20, thereby reducing the load transmitted to the connecting rod 30 and the first auxiliary link 40. The reciprocal motion of the piston 10 may be smoothly converted into the rotational motion of the crankshaft 50.

The crank pin 52 of the crankshaft 50 forms the third pivot point P3, and the first auxiliary linkage 40 may swing in the space between crank webs 54 of the crankshaft 50. In other words, the third pivot point P3 rotates along a predetermined radius with respect to the crankshaft 50, and the first auxiliary linkage 40 swings around the third pivot point P3.

The control shaft 80 and the crankshaft 50 rotate in the same direction. The compression ratio can be reduced by advancing the relative phase α of the control pivot CP with respect to the control shaft 80 according to the operation of the phase controller 90.

The control shaft 80 and the crankshaft 50 rotate in the same direction. The displacement may be increased by advancing the relative phase α of the control pivot CP with respect to the control shaft 80 according to the operation of the phase controller 90.

Here, the control shaft 80 and the crankshaft 50 may rotate synchronously. The relative phase α of the control pivot CP with respect to the control shaft 80, i.e., the relative phase α with respect to the crankshaft 50, may be changed, thereby changing the compression ratio and displacement.

According to the present disclosure, the engine may include the continuous variable displacement and variable compression ratio mechanism. The compression ratio and displacement are adjusted based on the operation state of the engine, thereby enabling improved engine performance and enhanced fuel efficiency.

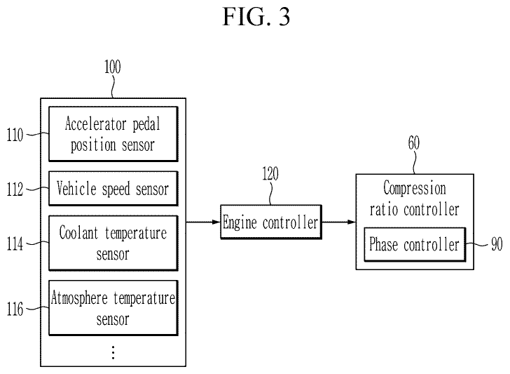

FIG. 3 is a schematic diagram of an engine provided with a continuous variable displacement and variable compression ratio mechanism according to the present disclosure.

Referring to FIGS. 1-3, the engine to which the continuous variable displacement and variable compression ratio mechanism is applied may include an operation status detecting part 100 that detects an operation status of a vehicle and outputs a corresponding signal. The engine may also include an engine controller 120 that controls the operation of the compression ratio controller 60 based on the output signal of the operation status detecting part 100.

The engine controller 120 may be implemented by one or more processors operating according to a predetermined program. The predetermined program may be programmed to perform each step of controlling the displacement and compression ratio of the engine according to the present disclosure.

The various embodiments described herein can be implemented within a recording medium readable by a computer or similar device, for example, using software, hardware, or a combination thereof.

In terms of hardware implementation, the embodiments described herein can be implemented using at least one of application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and/or other electrical units for performing functions.

In terms of software implementation, embodiments, such as the procedures and functions described in this specification, may be implemented as separate software modules. Each of the software modules can perform one or more functions and operations described in this specification. Software code can be implemented as a software application written in an appropriate programming language.

The operation status detecting part 100 may include various sensors related to the operation of the vehicle. For example, the operation status detecting part 100 may include: an accelerator pedal position sensor 110 that measures the operation status of an accelerator pedal and outputs a corresponding signal; a vehicle speed sensor 112 that measures the operating speed of a vehicle and outputs a corresponding signal; a coolant temperature sensor 114 that measures the temperature of a coolant and outputs a corresponding signal; and/or an atmosphere temperature sensor 116 that measures the temperature of the atmosphere and outputs a corresponding signal.

Additionally, the operation status detecting part 100 may further include various sensors related to vehicle operation, such as a brake pedal sensor, an engine torque sensor, and an oil temperature sensor.

Sensors, configurations, etc. related to vehicle operation status are known to those of ordinary skill in the art, so detailed descriptions have been omitted.

Based on the output signal of the operation status detecting part 100, the engine controller 120 controls the operation of the compression ratio controller 60. For example, the engine controller 120 may change the compression ratio and displacement by adjusting the relative phase α of the control pivot CP with respect to the reference phase RP of the control shaft 80.

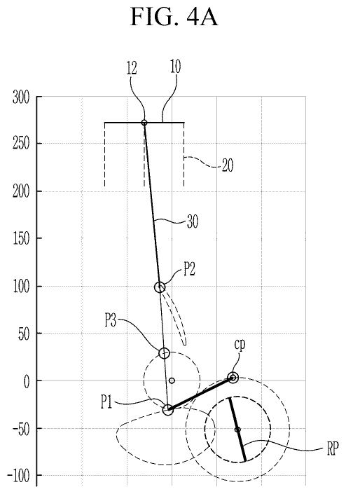

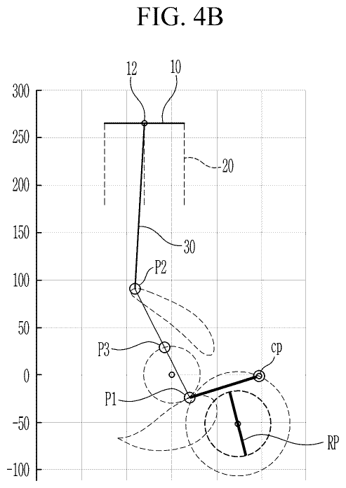

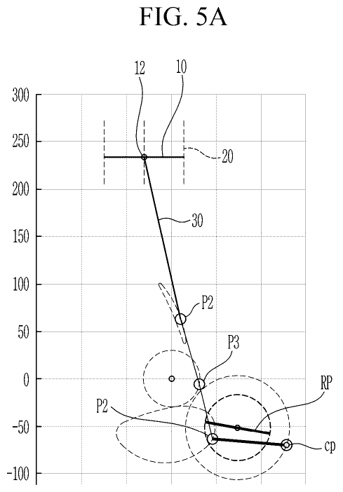

FIG. 4A-7B are drawings showing the operation of a continuous variable displacement and variable compression ratio mechanism according to the present disclosure.

Referring to FIGS. 4A, 5A, 6A, and 7A show the operation in a state where the relative phase α of the control pivot point CP to the reference phase RP of the control shaft 80 is 10 degrees. FIGS. 4B, 5B, 6B, and 7B show the operation in which the relative phase α of the control pivot point CP is advanced by 40 degrees with respect to the reference phase RP of the control shaft 80.

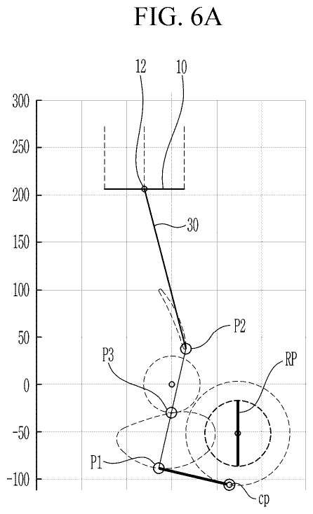

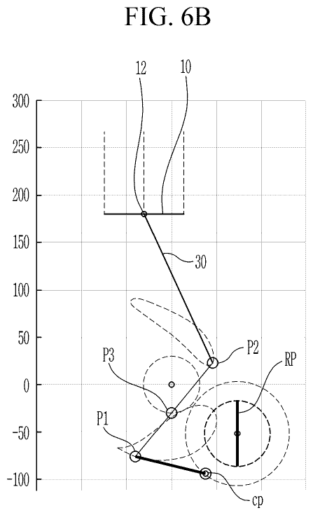

FIGS. 4A and 4B show the state when the position of the piston is top dead center. FIGS. 6A and 6B show the state when the position of the piston is bottom dead center.

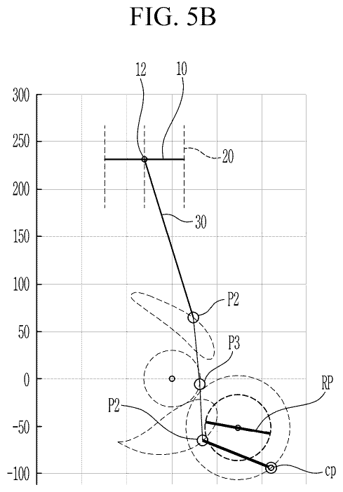

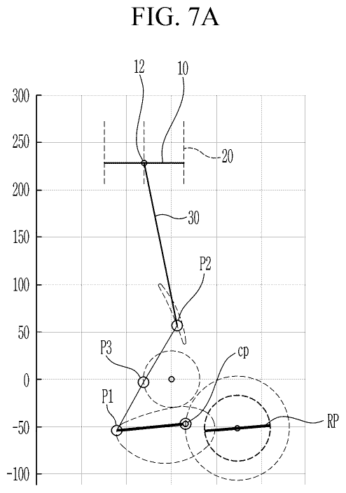

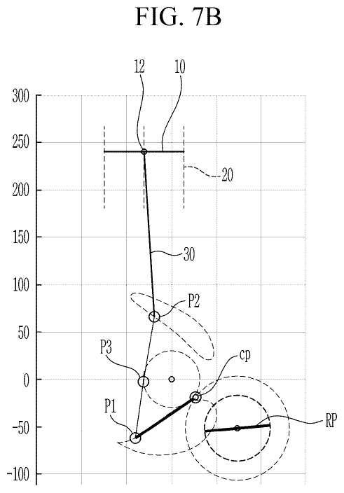

FIGS. 5A and 5B show the state when the position of the piston moves from top dead center to bottom dead center. FIGS. 7A and 7B show the state when the position of the piston moves from bottom dead center to top dead center.

Referring to FIG. 4 A, when the relative phase α of the control pivot CP with respect to the reference phase RP of the control shaft 80 is 10 degrees, the relative position of the top dead center with respect to the crankshaft 50 as a reference, for example, the relative position of the piston pin 12 is approximately 270 mm, and the connecting rod 30 and the first auxiliary linkage 40 are arranged in approximately a straight line.

Referring to FIG. 4B, when the relative phase α of the control pivot CP with respect to the reference phase RP of the control shaft 80 is 40 degrees, the connecting rod 30 and the first auxiliary linkage 40 are arranged out of a straight line. Therefore, the relative position of the top dead center with respect to the crankshaft 50 as a reference, for example, the relative position of the piston pin 12, is lowered to about 260 mm.

As shown in FIGS. 5A and 5B, the crankshaft 50 and the control shaft 80 rotate in the same direction and the piston 10 descends.

Referring to FIG. 6A, when the relative phase α of the control pivot CP with respect to the reference phase RP of the control shaft 80 is 10 degrees, the relative position of the bottom dead center with respect to the crankshaft 50 as a reference, for example, the relative position of the piston pin 12, is approximately 205 mm.

Referring to FIG. 6B, when the relative phase α of the control pivot CP with respect to the reference phase RP of the control shaft 80 is 40 degrees, the relative position of the bottom dead center with respect to the crankshaft 50 as a reference, for example, the relative position of the piston pin 12, is approximately 180 mm.

As shown in FIGS. 7A and 7B, the motion of the crankshaft 50 and the piston 10 continues, and the piston 10 shown in FIG. 4A and FIG. 7B moves to the top dead center.

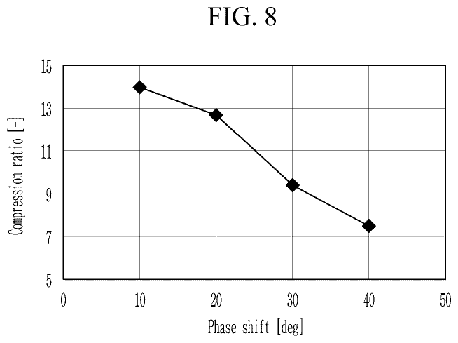

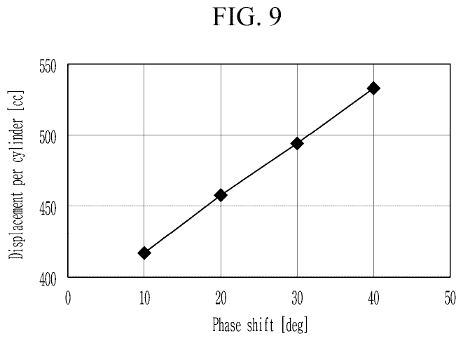

FIG. 8 is a graph showing the compression ratio variation according to phase change of a continuous variable displacement and variable compression ratio mechanism according to the present disclosure. FIG. 9 is a graph of displacement variation according to phase change of a continuous variable displacement and variable compression ratio mechanism according to the present disclosure.

As shown in FIGS. 4A-9, when the relative phase α of the control pivot CP with respect to the reference phase RP of the control shaft 80 is 10 degrees, the relative position of the top dead center is about 270 mm, the relative position of the bottom dead center is about 205 mm, the displacement may be about 417 cc, and the compression ratio may be about 14.0.

When the relative phase α of the control pivot CP with respect to the reference phase RP of the control shaft 80 is 40 degrees, the relative position of the top dead center is about 260 mm, the relative position of the bottom dead center is about 180 mm, the displacement may be about 533 cc, and the compression ratio may be about 7.5.

In other words, when the relative phase α of the control pivot CP with respect to the reference phase RP of the control shaft 80 increases from 10 degrees to 40 degrees, the compression ratio may be reduced by approximately 54% and the displacement may be increased by approximately 28%.

The continuous variable displacement and variable compression ratio mechanism may increase the compression ratio and decrease the displacement by controlling the relative phase α, or conversely, decrease the compression ratio and increase the displacement.

In other words, the continuous variable displacement and variable compression ratio mechanism according to the present disclosure may control the compression ratio and displacement in concert, i.e., in conjunction with one another.

As shown in FIG. 8 and in FIG. 9, the continuous variable displacement and variable compression ratio mechanism according to the present disclosure may continuously adjust the compression ratio and displacement, thereby maintaining an optimal operating state in various engine operation states.

The continuous variable displacement and variable compression ratio mechanism according to the present disclosure may improve fuel efficiency by implementing high compression ratio and low displacement under low load conditions. The mechanism may also improve output and fuel efficiency by implementing low compression ratio and high displacement under high load conditions.

The graphs shown in FIGS. 4A-7B are examples, and various types of compression ratios and displacements may be implemented.

For example, referring to FIG. 1, various types of compression ratios and displacements may be implemented according to the length L1 of the connecting rod 30, the length L2 between the second pivot point P2 and the third pivot point P3, the length L3 between the third pivot point P3 and the second pivot point P2, and the length L4 of the second auxiliary linkage 70.

In addition, for example, it is possible to implement various types of compression ratios and displacements according to the movement trajectory of the control pivot CP with respect to the control shaft 80, i.e., the driving radius L5 of the control pivot CP, the distance L6 between the control shaft 80 and the crankshaft 50, and the movement trajectory (driving radius; L7) of the crank pin 52.

In addition, for example, it is possible to implement various types of compression ratios and displacements according to the offset Δ of the rotation center of the crankshaft 50 and the driving direction of the piston pin 12, the arrangement angle β of the control shaft 80 with respect to the crankshaft 50, etc.

While the technical concepts of this disclosure have been described in connection with what are presently considered to be practical embodiments, it is to be understood that the present disclosure is not limited to the disclosed embodiments. On the contrary, the present disclosure is intended to cover various modifications and equivalent arrangements included within the spirit and scope of the appended claims.

<Description of symbols>

| | |
|---|---|
| 10: piston | 12: piston pin |
| 20: cylinder | 30: connecting rod |
| 40: first auxiliary linkage | 50: crankshaft |
| 52: crank pin | 54: crank web |
| 56: crankshaft rotation center | 60: compression ratio controller |
| 70: second auxiliary linkage | 80: control shaft |
| 90: phase controller | 101: first connecting pin |
| 102: second connecting pin | 103: control pin |
| P1: first pivot point | P2: second pivot point |
| P3: third pivot point | CP: control pivot |
| 100: operation status detecting part | |
| 110: accelerator pedal position sensor | |
| 112: vehicle speed sensor | 114: coolant temperature sensor |
| 116: atmosphere temperature sensor | 120: engine controller |

What is claimed is:

1. A continuously variable displacement and variable compression ratio mechanism comprising:
a connecting rod connected to a piston with a piston pin;
a first auxiliary linkage connected to the connecting rod;
a crankshaft connected to the first auxiliary linkage and rotatable by the first auxiliary linkage;
a second auxiliary linkage connected to the first auxiliary linkage;
a control shaft connected to the second auxiliary linkage; and
a phase controller configured to change the relative position of the second auxiliary linkage that is rotatable about the control shaft.

2. The continuously variable displacement and variable compression ratio mechanism of claim 1, wherein:
the second auxiliary linkage and the first auxiliary linkage are connected via a first pivot point;
the first auxiliary linkage and the connecting rod are connected via a second pivot point; and
the crankshaft and the first auxiliary linkage are connected via a third pivot point located between the first pivot point and the second pivot point.

3. The continuously variable displacement and variable compression ratio mechanism of claim 2, wherein the second auxiliary linkage and the control shaft are connected via a control pivot that is configured to rotate the exterior circumference of the control shaft.

4. The continuously variable displacement and variable compression ratio mechanism of claim 3, wherein:
the control shaft and the crankshaft are configured to rotate in the same direction; and
the compression ratio is reduced by advancing the relative phase of the control pivot to the control shaft according to the operation of the phase controller.

5. The continuously variable displacement and variable compression ratio mechanism of claim 3, wherein:
the control shaft and the crankshaft are configured to rotate in the same direction; and
the displacement is increased by advancing the relative phase of the control pivot to the control shaft based on the operation of the phase controller.

6. The continuously variable displacement and variable compression ratio mechanism of claim 2, wherein:
the crank pin of the crankshaft forms the third pivot point; and
the first auxiliary linkage is disposed to swing in the space between crank webs of the crankshaft.

7. The continuously variable displacement and variable compression ratio mechanism of claim 1, wherein the rotation center of the crankshaft is offset by a predetermined distance from the driving direction of the piston pin.

8. A continuously variable displacement and variable compression ratio mechanism comprising:
a connecting rod connected with a piston via a piston pin;
a first auxiliary linkage connected to the connecting rod;
a crankshaft connected to the first auxiliary linkage via a crank pin and configured to be rotated by the first auxiliary linkage; and
a compression ratio controller configured to change the movement trajectory of the connecting portion of the connecting rod and the first auxiliary linkage according to an operation status of the engine.

9. The continuously variable displacement and variable compression ratio mechanism of claim 8, wherein the compression ratio controller comprises:
a second auxiliary linkage connected to the first auxiliary linkage;
a control shaft connected to the second auxiliary linkage; and
a phase controller configured to change the relative position of the second auxiliary linkage that is rotatable about the control shaft.

10. The continuously variable displacement and variable compression ratio mechanism of claim 8, wherein:
the second auxiliary linkage and the first auxiliary linkage are connected by a first connecting pin;
the first auxiliary linkage and the connecting rod are connected by a second connecting pin; and
the crank pin is positioned between the first connecting pin and the second connecting pin.

11. The continuously variable displacement and variable compression ratio mechanism of claim 10, wherein the second auxiliary linkage and the control shaft are connected through a control pin that is configured to rotate the exterior circumference of the control shaft.

12. The continuously variable displacement and variable compression ratio mechanism of claim 11, wherein:
the control shaft and the crankshaft are configured to rotate in the same direction; and
the compression ratio is reduced by advancing the relative phase of the control pivot to the control shaft according to the operation of the phase controller.

13. The continuously variable displacement and variable compression ratio mechanism of claim 11, wherein:
the control shaft and the crankshaft are configured to rotate in the same direction; and
the displacement is increased by advancing the relative phase of the control pivot to the control shaft according to the operation of the phase controller.

14. An engine comprising the continuously variable displacement and variable compression ratio mechanism of claim 1.

15. An engine comprising the continuously variable displacement and variable compression ratio mechanism of claim 8.
